(19) United States
(12) Patent Application Publication
(10) Pub. No.: US 2011/0036928 A1
(43) Pub. Date: Feb. 17, 2011

(54) Method and Composition for Surface Coating

(76) Inventors: Dean William Dredge, Suffolk (GB); Shaun Barry Knight, Norfolk (GB)

Correspondence Address: SALIWANCHIK LLOYD & SALIWANCHIK;A PROFESSIONAL ASSOCIATION, PO Box 142950, GAINESVILLE, FL, 32614, US

(21) Appl. No.: 12/528,279

(22) PCT Filed: Feb. 19, 2008
(86) PCT No.: PCT/GB08/00574

§ 371 Date: Nov. 2, 2010

(30) Foreign Application Priority Data
Feb. 21, 2007 (GB) 0703319.4

(51) Int. Cl. B05B 7/32; C09D 5/00; G01B 21/00; B23P 6/00

(52) U.S. Cl. 239/337; 106/31.01; 106/31.96; 73/150 R; 29/402.19

(57) ABSTRACT

The subject invention concerns methods revealing surface imperfections on an object comprising the steps of: coating the surface to be inspected with a composition comprising an opaque, water-dispersible liquid, sufficiently surface-adherent and with surface-wetting properties as to create a gloss finish, at least before the liquid dries, on the restored area; inspecting the surface to check for imperfections; and removing said composition with water. The method may also include a step of marking the surface, through the wet composition layer, to indicate the location of imperfections discovered. Also described are compositions and delivery systems suitable for carrying out the method comprising aqueous dispersions of a pigment and a resin, especially a polysaccharide resin.

### FIELD OF THE INVENTION

The invention relates to surface coatings, especially temporary coatings, to assist in the visualisation of surface blemishes on articles of manufacture, particularly vehicle bodywork. The invention also relates to methods of manufacture or repair of items, particularly vehicle bodywork, where a smooth surface finish is required.

### BACKGROUND AND PRIOR ART KNOWN TO THE APPLICANT

Smooth, blemish-free finishes on manufactured items are at a premium, having great aesthetic appeal. This is particularly the case for vehicle finishes. If a vehicle body part is being made by hand or, more frequently, repaired following an accident, it is often required to remove dents and like deformations from the bodywork. It is necessary to hammer out, and/or fill the deformed area accurately to restore its original shape. In order to carry this out, the original paint coating (typically of a gloss finish) is usually removed first. Following re-shaping, the part will need to be re-painted. Prior to repainting, however, it would be valuable to know whether the original shape of the deformed area has been accurately restored. It is difficult to determine this, either by eye or by feel, when the area constitutes an interruption to the overall contour of the vehicle body by virtue of filler, rubbed-down paint etc, having a different colour and surface reflectivity to the surrounding areas.

In practice, the areas are reshaped to the best of the technician's ability and the panel surface is repainted, often using expensive finishes, including volatile organics, of high durability and longevity; i.e. the final required, usually glossy, paint finish. In order to do this, surrounding areas need to be masked to prevent stray paint (known as “overspray” in the trade) landing on adjacent areas; e.g. in the context of car repairs, windscreens, door handles, bumpers, metal trim, tyres and wheel hubs might need to be protected from such overspray. Only when this is completed can the acceptability of the repair or manufacture be properly judged; the reflection of light from the surface amplifies any surface blemishes to reveal remaining defects. If defects are found, the just-applied paint finish must be removed, and the repair attempted again. To remove the paint finish, volatile solvents must again be used again, adding to operational difficulties and environmental concerns. If this process is not used then another method involves the use of abrasives to remove the paint layers. This is not only time consuming but actually damages the substrate further, leading to further filling of the area to regain the contours. Either way is extremely expensive for the business as the whole process is then repeated until a satisfactory surface finish is achieved. Not only is this extremely time-consuming, thereby adding to the cost of the repair (labour cost is typically the highest factor in the repair process), but the use of solvent-based paint removers has negative environmental consequences and is unpleasant for the operator: Fume extraction equipment needs to be used during the paint process, which might require the vehicle or panel to be moved from a bodywork repair area to a solvent spray facility. Again, all this adds to the cost and time inefficiency of the process.

Whilst this problem is perhaps most common in the field of car bodywork repair, similar issues arise in the repair of other vehicles such as vans, motorbikes, lorries, trains, coaches, aeroplanes, boats and ships. The repair of boat hulls is often carried out using specialist wood finishes. These again require a high quality surface finish for aesthetic reasons, and—for boat hulls especially—also to minimise drag when in the water. Boat hulls may be made of wood, glass-fibre or carbon-fibre composites that often need to be sanded during repair or finishing operations. These activities create dust, and so the re-shaping exercise is carried out away from any paint or varnish application area to prevent dust spoiling other articles undergoing re-finishing. Again, the use of solvent-based paints and varnishes requires fume extraction, and the same problems of moving items to and from the painting areas are apparent, as are the inherent difficulties and associated costs of needing to re-paint or re-varnish the article before the quality of the finish can be determined.

In other areas of manufacture, such as the production of art objects such as sculptures and ceramics, a high quality gloss finish is often required. In these fields, the quality of the finish is not, however, revealed until a final gloss coating, such as a ceramic glaze or a paint finish is applied. Failure to achieve the required surface finish before this final coating operation again leads to the need to remove the coating (if indeed this is possible) and repeat the finishing operations.

International patent application WO 94/04617 discloses polyethylene glycol based compositions that may be applied by wiping or the use of mechanical rotating brushes.

Japanese patent application JP2005-257512 discloses agents for detection of defects in metal sheets, again comprising glycol-type solvents.

UK patent GB 1091958 discloses the use of a fluorescent penetrants to highlight flaws such as cracks in the surface of objects such as ball bearings.

### SUMMARY OF THE INVENTION

Accordingly, the invention provides a method of revealing surface imperfections on vehicle bodywork comprising the steps of: (a) coating the surface to be inspected with a composition comprising an aqueous solution, or dispersion, of a polysaccharide resin and a pigment; (b) inspecting the surface to check for imperfections; (c) removing said composition with water. Preferably, the composition is removed before it has dried. Preferably also, the coating is of a dark colour. The inventors have found that the use of a dark colour (especially black) is particularly effective at revealing surface blemishes.

Included within the scope of the invention is a method of revealing surface imperfections substantially as described herein.

In a second aspect, the invention also provides a method of repairing a deformation in the bodywork of a vehicle comprising the steps of: (i) nominally restoring the bodywork to the required shape; (ii) revealing surface imperfections in the nominally restored bodywork according to a method described above; (iii) repeating from step (i), if required, until the desired shape has been achieved.

A particular benefit of using such a temporary coating that creates a gloss finish when wet is that any defects identified during inspection can be marked on the piece (e.g. the bodywork panel) whilst the coating is in place: After applying the coating, if e.g. a defect is noticed, an operator can use a marker such as a pencil to identify the position of the defect on the underlying panel; the still-liquid nature of the coating allows the marker to penetrate the coating and deposit a mark on the surface. When the temporary coating is removed, the mark remains on the panel surface, indicating where further work is required.

Accordingly, the method of repairing a deformation preferably further comprises the step of marking the surface of the bodywork, through the coating of composition, to indicate the location of a surface imperfection so revealed, before removing said composition.

If it is desired that the method be used on items not in a horizontal orientation, then a thickener may also be added to the liquid to prevent “sagging”. Suitable thickeners are described below.

As well as being water-dispersible, it is particularly beneficial if a water soluble such liquid is employed—this prevents any residue remaining on the surface after subsequent removal.

The use of a water-dispersible (or water-soluble) finish provides numerous benefits: As the coating is readily removable, no masking of surrounding areas is required, as any overspray can be readily removed e.g. with a damp cloth. Whilst the temporary coating can be removed with water alone—and especially warm water—the use of water with other agents further facilitates the removal of the coating. For example, the inventors have found that the use of proprietary water-borne degreasers or water containing ammonia is particularly effective.

Also included within the scope of the invention is a method of repairing a deformation in a panel (e.g. the bodywork of a vehicle) substantially as described herein.

In a third aspect, the invention also provides a liquid surface covering composition, suitable for carrying out a method described above, comprising an aqueous solution, or dispersion, of: a polysaccharide resin at a concentration of more than 30% by weight; and a pigment. In further preferred embodiments, the polysaccharide resin may be at a concentration of more than 32%, 35%, 38%, or even more than 40% by weight.

Suitable resins may be chosen by the skilled addressee to meet the criteria of opacity, water-dispersibility and surface adherence as described herein.

Also included within the scope of the invention is a liquid surface covering composition substantially as described herein.

In a fourth aspect, the invention also provides an aerosol can or spray gun containing a liquid composition for highlighting defects in contoured surfaces, said liquid composition comprising an aqueous solution, or dispersion, of a polysaccharide resin and a pigment.

Also included within the scope of the invention is an aerosol can or spray gun containing a liquid composition for highlighting defects in contoured surfaces, substantially as described herein.

A number of different polysaccharide resins may be employed in any aspect of the invention, such as starch, gum acacia, xanthan gum, maltodextrins, dextrins, or cellulose. These may be obtained from a variety of botanical sources including tapioca, wheat, maize and potato. In order to increase the solubility of the polysaccharide resin in water, pre-treatments may be carried out on the resins such as pre-gelatinisation by heat treatment, or treatment with acid or heat to reduce the molecular chain length of the polysaccharides. Such pre-treatment not only increases the solubility, but also provides a means for adjusting the rheological properties of the compositions so formed. By routine workshop experimentation, the skilled addressee will be readily able to select a suitable polysaccharide resin and concentration to give a composition that evenly covers a surface to be inspected or, in the case of spray application, provides a composition of suitable rheological properties for spray delivery.

However, amongst the polysaccharide resins, starches are particularly preferred, especially pre-gelatinised starches, such as a pre-gelatinised maize starch.

In order to provide a composition that may readily be used without sophisticated fume extraction or the like, it is particularly preferred that any composition according to the invention is essentially free of volatile organic solvents. It is also preferred that any composition is essentially free of glycol or polyethylene glycol. It is further particularly preferred that pigments used in any composition should be substantially non-fluorescent.

It will be appreciated that the coatings described herein may be applied to flat or contoured bodywork, and that they may be applied either directly to the base substrate, e.g. bare metal, wood, glass fibre etc., or may be applied to such a substrate after application of a filler, or of a priming paint layer, e.g. a manufacturer's primer, or other surface coating. Any such surface coating or filler should be dry before applying the compositions described herein, to prevent inadvertent damage to the surface when the composition is removed.

### DESCRIPTION OF PREFERRED EMBODIMENTS

In one particularly preferred embodiment, the composition is formulated by first preparing a polysaccharide resin solution, and then using this to formulate the final composition. The polysaccharide resin solution has a composition as follows:

Polysaccharide Resin Solution

| Component | Volume % | Weight % |
|---|---|---|
| Water | 56.53 | 44.98 |
| Polysaccharide resin | 43.44 | 55.00 |
| Preservative | 0.02 | 0.02 |
| Total | 100 | 100 |

In specific, and preferred, embodiments the polysaccharide resin may comprise a heat-treated starch, such as corn starch. The inventors have found that the polysaccharide resin available under the trade name ECO-100, and commercially available from Lorama Chemicals Inc., Milton Ontario, Canada, is particularly effective. Also particularly effective are the polysaccharide resins available under the trade names JA 250-3 and LPR76, also available from Lorama Chemicals Inc. Suitable polysaccharide resins will be water soluble, or at least readily water-dispersible.

The preservative is optional for functioning of the composition, but is effective at increasing the shelf life of both the product and the Polysaccharide Resin Solution premix. A suitable, and effective preservative is sold under the trade name “Kathlon LX” and commercially available from Rohm and Haas (UK) Ltd., Westgate, Aldridge West Midlands, UK.

Whilst this formulation has been found to be particularly effective, the skilled addressee may vary the composition from these exact figures. The following ranges of concentration have been found to be effective, with other components being adjusted, of course, to bring the total to 100 weight %:

Polysaccharide Resin Solution

| | Weight % | Weight % |
|---|---|---|
| Component | Lower limit | Upper Limit |
| Water | 35 | 55 |
| Polysaccharide resin | 45 | 65 |
| Preservative | 0 | 0.1 |
| Total | 100 | 100 |

This polysaccharide resin solution is then used to produce the complete formulation; a particularly effective composition is:

Complete Formulation

| Component | Volume % | Weight % |
|---|---|---|
| Polysaccharide Resin Solution | 71.05 | 72.60 |
| Water | 13.4 | 10.89 |
| Rheology Modifier (e.g. Rheolate ® 420) | 0.31 | 0.27 |
| pH Regulator (e.g. Angus ® AMP95) | 0.21 | 0.16 |
| Pigment (e.g. Creanova ® 888-9907B) | 13.89 | 15.18 |
| Surfactant (e.g. Surfynol ® 104H) | 0.71 | 0.55 |
| Surfactant (e.g. Surfynol ® DF75) | 0.44 | 0.36 |
| Total | 100 | 100 |

The rheology modifier, or thickener, may be added to give the surface coating “body”, i.e. to prevent the coating running or sagging when first applied, especially when being applied to a non-horizontal surface. For some applications where the surface to be coved is always in the horizontal plane during application, the rheology modifier may be omitted. The inventors have found that Rheolate® 420, an aqueous polyacrylate, at the above concentration is particularly effective. The skilled addressee may substitute this for an alternative thickener if required, determining an appropriate concentration so as to approximately match the viscosity imparted by the concentrations of Rheolate® 420 identified herein, by routine experimentation. Rheolate® 240 is available commercially from Elementis Specialites, Diegam, Belgium, and other suppliers worldwide.

The pH regulator is added to adjust the pH to approximately pH8, to increase the colloidal stability of the product, and help preserve the composition against microbial attack. It is not essential for functioning of the product, but gives distinct benefits. The inventors have found that the use of Angus® AMP95, (2-amino-2-methyl-1-propanol) at the above concentration is particularly effective. This is widely available commercially from Angus Chemical Company, a division of the Dow Chemical Company.

The pigment is essential to the formulation, and is added to give the desired colour. The inventors have found that a dark colour, such as black, is particularly effective at revealing surface blemishes. Alternatively, the colour may be chosen to match that of the surrounding colour of the article to be coated. In this particular embodiment, the pigment Creanova® 888-9907B is employed; this is essentially “lamp black” and is available commercially from Degussa, Düsseldorf, Germany, and elsewhere.

Surfactant may be added to improve the compositions ability to wet the surface to which it is applied. The inventors have found that the above surfactants, available from Air Products and Chemicals Inc., USA, and elsewhere are particularly effective.

Again, whilst this formulation has been found to be effective, the skilled addressee may vary the composition from these exact figures. The following ranges of concentrations have been found to be particularly effective, with other components being adjusted, of course, to bring the total to 100 weight %:

Complete Formulation

| | Weight % | Weight % |
|---|---|---|
| Component | Lower limit | Upper Limit |
| Polysaccharide Resin Solution | 65 | 80 |
| Water | 9.5 | 12 |
| Rheology Modifier (e.g. Rheolate ® 420) | 0.2 | 0.3 |
| pH Regulator (e.g. Angus ® AMP95) | 0.15 | 0.2 |
| Pigment (e.g. Creanova ® 888-9907B) | 13.5 | 17 |
| Surfactant (e.g. Surfynol ® 104H) | 0.45 | 0.6 |
| Surfactant (e.g. Surfynol ® DF75) | 0.3 | 0.4 |
| Total | 100 | 100 |

This formulation may then be applied to an article to be coated by use of a spray gun, e.g. such as those commonly available in the automotive bodywork repair industry. Alternatively, it may be dispensed from aerosol cans by use of a suitable propellant, commonly available in the spray paint industry, or by a “pump-action” spray device.

The inventors contemplate that compositions described herein will also find application in other fields where a temporary, water-removable, opaque (and especially gloss) finish is desired. Examples would include coatings to temporarily obscure glass (e.g. on windows of buildings to provide temporary privacy during refurbishment works and the like) and novelty temporary “spray paint” to simulate permanent spray paint such as that used by graffiti creators.

We claim:

1. A method of repairing a deformed area of the bodywork of a vehicle following an accident comprising the steps of:
(a) revealing surface imperfections in the vehicle bodywork by coating the surface to be inspected with a composition comprising a pigmented aqueous solution or dispersion, and inspecting the surface by eye to check for imperfections; and
(b) removing said composition.

2. The method according to claim 1, further comprising the steps of:
(i) nominally restoring the deformed area of the bodywork to the required shape;
(ii) revealing surface imperfections in the nominally restored bodywork according to the method of claim 1;
(iii) repeating from step (i), if required, until the desired shape has been achieved.

3. The method according to claim 2, in which the step of nominally restoring the deformed area of the bodywork to the required shape includes removing the original paint coating from the deformed area of the bodywork.

4. The method according to claim 2, in which the step of nominally restoring the deformed area of the bodywork to the required shape includes hammering out and/or filling the deformed area.

5. The method according to claim 2, in which the composition is applicable over all portions of the nominally restored deformed area of the bodywork, including any remaining areas of the base substrate (e.g. bare metal, wood, or glass-fibre), areas of filler or composites, and any priming paint layers or other surface coating.

6. The method according to claim 5, in which the composition is opaque to enable visualisation of surface blemishes despite the different colours and surface reflectivities of the portions of the nominally restored area of the bodywork.

7. The method according to claim 1, in which during the coating of the surface of the deformed area of the bodywork with the composition, surrounding areas of the bodywork are not masked.

8. The method according to claim 1, wherein the composition is removed before it has dried.

9. The method according to claim 1, wherein the coating is of a dark colour.

10. The method according to claim 1, further comprising the step of marking the surface of the bodywork, through the coating of composition, to indicate the location of a surface imperfection so revealed, before removing said composition.

11. The method according to claim 1, in which the composition comprises a solution or dispersion of a polysaccharide resin.

12. A liquid, vehicle-bodywork-covering, imperfection-revealing composition, for carrying out a method of repairing a deformed area of bodywork of a vehicle, said composition comprising a pigmented aqueous solution or dispersion.

13. The liquid, vehicle-bodywork-covering, imperfection-revealing composition, according to claim 12, comprising a polysaccharide resin at a concentration of more than 30% by weight.

14. An aerosol can or spray gun containing a liquid, vehicle-bodywork-covering, imperfection-revealing composition comprising a pigmented aqueous solution or dispersion.

15. A method of revealing surface imperfections on vehicle bodywork comprising the steps of:
(a) coating the surface to be inspected with a composition comprising an aqueous solution or dispersion, of a polysaccharide resin and a pigment;
(b) inspecting the surface to check for imperfections;
(c) removing said composition with water.

16-18. (canceled)

19. The aerosol can or spray gun according to claim 14, wherein the liquid, vehicle-bodywork-covering, imperfection revealing composition comprises a polysaccharide resin at a concentration of more than 30% by weight.
